(19) United States
(12) Patent Application Publication
(10) Pub. No.: US 2025/0073909 A1
(43) Pub. Date: Mar. 6, 2025

(54) METHOD FOR ASSISTING AN OPERATOR IN OPERATING A TELEROBOT SYSTEM

(71) Applicant: Honda Research Institute Europe GmbH, Offenbach/Main (DE)

(72) Inventors: Thomas Weisswange, Offenbach (DE); Mathias Franzius, Offenbach (DE); Dirk Ruiken, Offenbach (DE)

(73) Assignee: Honda Research Institute Europe GmbH, Offenbach/Main (DE)

(21) Appl. No.: 18/757,536

(22) Filed: Jun. 28, 2024

Related U.S. Application Data
(60) Provisional application No. 63/524,211, filed on Jun. 29, 2023.

(51) Int. Cl. B25J 9/16; B25J 13/06

(52) U.S. Cl. CPC B25J 9/1689; B25J 13/06

(57) ABSTRACT

Disclosed is a method and corresponding system for assisting an operator in operating a telerobot system. The telerobot system comprises a robot, at least one sensor, a processing unit and an operator interface. First the system physically senses a working area of the robot by the at least one sensor. Based on the sensor information, the system detects objects and estimates at least one of an object property, object state and object relation to another object. Further, the system estimates, for at least one object, an actual scene uncertainty related to the object, and predicts a modified scene uncertainty related to the object assuming a scene modification. Finally, it determines whether the modified scene uncertainty has improved compared to the actual scene uncertainty and, if an improvement is determined, communicates the corresponding scene modification using the operator interface.

### CROSS REFERENCE TO RELATED APPLICATIONS

This application claims the priority benefit of U.S. Patent provisional Application No. 63/524,211, filed on Jun. 29, 2023. The entirety of the above-mentioned patent application is hereby incorporated by reference herein and made a part of this specification.

### BACKGROUND

### Technical Field

The disclosure relates to the field of assisting an operator in operating a tele-robot-system, in particular to AI assisted systems that rely on at least partially autonomous scene perception and interpretation.

### Description of Related Art

Object 6D pose estimation is a critical task for a range of robotic applications, such as object localization, grasping, and manipulation, specifically in tele operated robotic setups with AI assistance. Occlusion of objects resulting in an uncertainty of pose determination of the occluded object present in the scene in a working area of the robot leads to reduced understanding of the encountered scene. While some tasks like grasping can be solved with ad-hoc methods, i.e., without knowledge of the full object pose, many more complex tasks do require this knowledge, e.g., applying a tool or stacking objects. Although extensive work has been done on object pose estimation, it is still under active research. The diversity of scenarios and noise sources present significant challenges for researchers, especially compared to non-robotics scenarios, which are often based on pre-recorded benchmark datasets.

Generally, it is possible for the operator to improve the scene understanding of the robot by manipulating objects in the work area of the robotic system based on his own scene understanding. The operator could move irrelevant objects to another position so that the relevant objects are no longer occluded and perceivable by the sensors of the robotic system more accurately. However, for the operator it is often not possible to recognise which manipulation of an object and which scene modification would be advantageous for the scene understanding of the robot such that the AI assistance performed by the robot improves. It is to be noted that the robot is typically equipped with a plurality of sensors and the information provided by the sensors are combined to achieve scene knowledge. The scene understanding of the robot is based on this combined scene knowledge. This is particularly relevant for systems, in which the work area which is the environment of the robot is remote from the operator (teleoperated systems). For the operator it is not possible to understand which sensor result must be improved in order to improve the overall AI assistance, because the operator must base his own scene understanding on information that is provided by the system, for example a main camera view.

Because of its relevance for AI-based assistance systems, 3D object detection and 6D pose estimation are widely studied in the field of computer vision. Hoque, Sabera, et al. “A Comprehensive Review on 3D Object Detection and 6D Pose Estimation with Deep Learning.” IEEE Access 9 (2021): 143746-143770 recently published a comprehensive review paper regarding pose estimation methodology. Xiang, Yu, et al. “PoseCNN: A convolutional neural network for 6D object pose estimation in cluttered scenes.” arXiv preprint arXiv:1711.00199 (2017) describes PoseCNN, a new convolutional neural network for 6D object pose estimation. PoseCNN estimates object 3D translation by localizing its centre in the image and predicting the distance from the camera, and estimates 3D orientation by regressing to a quaternion representation. DenseFusion disclosed in Wang, Chen, et al. “DenseFusion: 6d object pose estimation by iterative dense fusion.” Proceedings of the IEEE/CVF conference on computer vision and pattern recognition. 2019 is a heterogeneous model inspired by PoseCNN. DenseFusion estimates object pose from RGB-D data by leveraging the two complementary data sources of depth and appearance. Such data-driven models require the consistency of illumination and unchanged object texture. Hence, it is hardly used in practice. Pose estimation by leveraging RGB and RGB-D is currently still the mainstream.

Evaluation of 6D pose estimates is not so straightforward due to object occlusions and object symmetries. Thus, Hodaň, Tomáš, Jiří Matas, and Štěpán Obdržálek. “On Evaluation of 6D Object Pose Estimation.” Computer Vision-ECCV 2016 Workshops: Amsterdam, The Netherlands, Oct. 8-10 and 15-16, 2016, Proceedings, Part III 14. Springer International Publishing, 2016 proposes an evaluation methodology and presents three novel loss functions.

Deng, Haowen, et al. “Deep Bingham networks: Dealing with uncertainty and ambiguity in pose estimation.” International Journal of Computer Vision 130.7 (2022): 1627-1654 proposes an elegant end-to-end model of pose distribution for 3D rotation and translation by using Gaussian and Bingham models which highly relies on manual annotations. Further, Bui, Mai, et al. “6D Camera Relocalization in Ambiguous Scenes via Continuous Multimodal Inference.” Computer Vision-ECCV 2020: 16th European Conference, Glasgow, UK, Aug. 23-28, 2020, Proceedings, Part XVIII 16. Springer International Publishing, 2020 describes a multimodal camera relocalization framework, which captures the ambiguities and uncertainties of camera poses by leveraging continuous mixture models, in which Gaussian probability distribution is used for Euclidean translation uncertainty and Bingham distribution is used for symmetric orientation uncertainty. Furthermore, Shi, Guanya, et al. “Fast Uncertainty Quantification for Deep Object Pose Estimation.” 2021 IEEE International Conference on Robotics and Automation (ICRA). IEEE, 2021 proposed a fast uncertainty quantification model for object pose estimation. The main concept is to utilize multi pre-trained models, e.g., DOPE, to compute the pairwise disagreement against one another to obtain the uncertainty.

The concept of active perception appeared three decades ago, e.g., described in Bajcsy, Ruzena, Yiannis Aloimonos, and John K. Tsotsos. “Revisiting Active Perception.” Autonomous Robots 42 (2018): 177-196, which summarizes most of relevant literature regarding active perception.

Improvements of the quality of a teleoperation system can be measured quantitatively, e.g., by duration of task, task success rate, sense of awareness, sense of telepresence, and mental workload as disclosed in D. Rea and H. Seo: “Still Not Solved: A Call for Renewed Focus on User-Centered Teleoperation Interfaces.” Front. Robot. AI, 2022, https://doi.org/10.3389/frobt.2022.704225 or D. Gopinath, S. Jain and B. D. Argall, “Human-in-the-Loop Optimization of Shared Autonomy in Assistive Robotics.” IEEE Robotics and Automation Letters, 2017, doi: 10.1109/LRA.2016.2593928.

In “Shared Autonomy for Intuitive Teleoperation” (39^{th} IEEE International Conference on Robotics and Automation (ICRA 2022) Workshops: Shared Autonomy in Physical Human-Robot Interaction: Adaptability and Trust), Dirk Ruiken and Simon Manschitz describe a virtual reality based shared autonomy teleoperation framework that provides support for the human operator during object interactions, e.g., for pick and place tasks. The described framework allows for a better understanding of the current situation by providing visual and haptic cues to the operator. Additionally, based on the estimated intention of the operator, the system can autocorrect the operator's commands to semi-autonomously guide the robot towards the current goal when appropriate. By retaining the operator's sense of agency, the system increases the operator's trust in the system.

Dirk Ruiken et al describe an active, model-based recognition system in “Affordance-based active belief: Recognition using visual and manual actions.” (2016 IEEE/RSJ International Conference on Intelligent Robots and Systems (IROS). IEEE, 2016). The described system applies information theoretic measures in a belief-driven planning framework to recognize objects using the history of visual and manual interactions and to select the most informative actions. A generalization of the aspect graph is used to construct forward models of objects that account for visual transitions. Populations of these models are used to define the belief state of the recognition problem. This paper focuses on the impact of the belief-space and object model representations on recognition efficiency and performance. A benchmarking system is introduced to execute controlled experiments in a challenging mobile manipulation domain. It offers a large population of objects that remain ambiguous from single sensor geometry or from visual or manual actions alone. Results are presented for recognition performance on this dataset using locomotive, pushing, and lifting controllers as the basis for active information gathering on single objects. An information theoretic approach that is greedy over the expected information gain is used to select informative actions, and its performance is compared to a sequence of random actions.

Before the specific aspect of the present invention is explained in greater detail below, some general considerations regarding the consequences of uncertainty in pose estimation of an object in a scene, shall be presented. Given realistic sensor noise and complexities like object symmetries, estimating one definite pose is often only possible with insufficient confidence. However, some pose uncertainties may not be detrimental for a task, and knowing the uncertainty could be compensated with appropriate behaviour:

For robotics, knowledge about the exact pose of an object is not always required, as it can be sufficient to know the exact location of one graspable object part, e.g., a mug's handle.

Object symmetries may render certain pose dimensions irrelevant, e.g., the yaw angle of an upright cylindrical can is not important for grasping it.

Behaviour can take some dimensions of high uncertainty into account and still result in robust execution, e.g., one uncertain position dimension may be ignored if the hand approaches from that direction in a sweeping grasp, pushing the object into a defined pose.

Thus, the tolerable variance in pose distributions depends on the specific task. However, especially for AI assisted systems, it is important that the scene understanding of the robot allows to decide on an plan operations based on scene recognition with sufficient certainty. An improvement of uncertainty in the detection or estimation of properties and states of objects involved in task achievement is therefore desired. Further, the cooperative execution of a task is improved when the operator understands the limitations coming derived from scene perception using the sensors of the robotic system.

### SUMMARY

The present invention provides a method for assisting an operator in operating a telerobot system, in which the telerobot system comprises a robot, at least one sensor, a processing unit and an operator interface. The method comprising the steps of: physically sensing a working area of the robot by the at least one sensor; detecting objects based on the sensor outputs and estimating at least one of an object property, object state and object relation to another object; estimating, for at least one of the detected objects, an actual scene uncertainty related to the object; predicting a modified scene uncertainty related to the object assuming a scene modification; and determining whether the modified scene uncertainty has improved compared to the actual scene uncertainty and, if an improvement is determined, communicating the corresponding scene modification using the operator interface. The corresponding scene modification is the scene modification assumed for predicting the modified scene uncertainty.

The actual scene uncertainty related to the object may concern any information derived from the scene physically sensed by the sensors of the robot. The modified scene uncertainty is the corresponding uncertainty for the same aspect but based on a modified scene in which for example at least one object present in the scene is moved to another position or removed, which means moved out of the field of view of the robot's sensors. For example, an object occluding parts of another object, which needs to be manipulated in order to achieve a certain task, is removed or at least moved to another position in the modified scene. Accordingly, the sensors, including for example a plurality of cameras attached to the robot or distributedly arranged in the work area of the robot, can obtain information on the entire object of the previously occluded object. Thus, the uncertainty, for example uncertainty of a pose estimation, identification of an object or classification of the object type in the modified scene is improved compared to the initial or actual scene. The operator interface is then used to provide the operator with respective information on the modification of the scene, which is considered to provide improved uncertainty on information required for task achievement. The determination of the effects of a modification in the scene is carried out by the system based on a modification of the scene (a virtual change of the scene) which does not need an actual manipulation performed by the operator or the robot itself. In case that the virtual (assumed) modification of the scene is determined to result in an improved uncertainty regarding at least one aspect in the perceived scene in the work area of the robot, the operator is informed about the corresponding modification of the scene. Thus, in response to such a modification being communicated to the operator, the operator can adapt the operation of the robotic system, for example by causing the robot to move an occluding object to another position or to entirely remove it. The modified scene uncertainty is calculated in the same way as the actual scene uncertainty but using information on the modified scene instead of information on the actual scene as input for the calculation.

The method according to the invention is carried out by a robotic system comprising the robot, one or more physical sensors for obtaining information on the environment (work area) of the robot based on which the robot understands the scene. The teleoperated robotic system comprises a processor or a combination of a plurality of processors with dedicated functionality, which preferably execute a plurality of software modules implementing the functions explained with respect to the inventive method. The system further comprises an operator interface at least comprising means for outputting, preferably visualising, information on the scene modification to the operator resulting in an improvement of the modified scene uncertainty compared to the actual scene uncertainty.

### BRIEF DESCRIPTION OF THE DRAWINGS

Further advantages and aspects of the present invention are described with reference to the attached drawings.

FIG. 1 shows a structure of an embodiment of a robotic system according to the present invention implementing the inventive method.

FIG. 2 shows a flowchart illustrating the main method steps according to the present invention.

FIG. 3 illustrates the effect of the present invention.

FIG. 4 shows examples for communicating the assumed scene modification to the operator of the teleoperated robotic system.

The detailed description of the accompanying figures uses same reference numerals for indicating same, similar, or corresponding elements in different instances. The description of figures dispenses with a detailed discussion of same reference numerals in different figures whenever considered possible without adversely affecting comprehensibility. Generally, operations of the disclosed processes may be performed in an arbitrary order unless otherwise provided in the claims.

### DETAILED DESCRIPTION

The system is not limited to determining a single modification in a scene, but may also identify a plurality of possible modifications that would result in an improvement of one or more uncertainties. Further, the explanations mostly refer to pose estimation of an object but this is only used as an illustrative example. According to an advantageous embodiment, the method comprises a step of selecting one or more scene modifications from the entirety of determined possible see modifications based on a predicted future operation of the operator. It is possible to predict the next steps that are taken by an operator of the system. Taking into consideration the operator's next step or next steps allows to discriminate between relevant objects and objects unrelated to such next step. Making suggestions by communicating modifications of the scene resulting in an improvement of an uncertainty only achieves the desired effect if the overall performance of the system is improved. For example, in case that a pose estimation of an object can only be made with high uncertainty, this is irrelevant in case that the object will not be involved in the operator's next step. Thus, according to this aspect of the invention, the respective modification although resulting in an improved uncertainty, will not be communicated to the operator.

Further, the system may be adapted to be able to divide a task into a plurality of subtasks and to optimise the sequence of the subtasks. This sequence is determined such that the uncertainty is optimised. The resulting sequence leading to the improved uncertainty is then communicated to the operator. For example, in a shelf stacking task, it is advantageous to first pick closest sensor-occluding objects instead of starting with faraway occluded objects.

It is further advantageous and specifically preferred to provide additional information when communicating information on scene modifications to the operator. The communication of the scene modification preferably includes outputting information on the determined uncertainty improvement. For example, the initial uncertainty (actual scene uncertainty) but also the modified seen uncertainty regarding the specific object could be displayed related to the respective object. Alternatively, only the actual seem uncertainty or the modified scene uncertainty could be communicated to the operator.

In addition or alternatively, the costs for achieving the modified scene can also be communicated to the operator. Such costs may specifically be the time that is additionally needed for the manipulation necessary in order to achieve the modified scene.

Further, it is possible that the operator initiates the analysis of the scene with respect to uncertainty improvement by inputting a request specifying a particular (or a plurality of) actual scene uncertainties. The system will then analyse if a modification of the scene is possible which results in an improvement of this specified uncertainties. An operator request that is input by the operator may for example identify an object determined in the scene of the work area, and the uncertainties of properties related to this object or states of the object are then evaluated with respect to potential scene modifications. In case that a scene modification can be identified that results in an improvement of at least one uncertainty related to the specified object, this will be communicated to the operator in response to his request.

According to another preferred embodiment, the robot may have the functionality to autonomously execute manipulations resulting in scene modification corresponding to a determined improvement of the modified scene uncertainty. Although the operator still may be informed about the determined corresponding modification, the operator is not required to react on such information, because the robotic system by itself is able to execute the necessary manipulations in order to achieve the modified scene. It is also possible that using the operator interface, the operator is informed about the robot autonomously performing the necessary manipulations. This avoids that the robot and the operator act contradictive.

It is specifically preferred that the operator interface visualises the actual scene for communicating identified scene modifications. This may be done, for example, using augmented reality devices or by displaying a representation generated based on the physically sensed environment and including, for example by overlay, the information on the actual scene uncertainty, or even modified scene uncertainty. It is also possible to include both, the actual scene uncertainty and also the modified scene uncertainty.

Uncertainties that may be considered when implementing the method according to the present invention can be at least one of: pose of an object, object existence, object detection, object classification, classification of object instance, object state, relation between the object and at least one other object, prediction of dynamical object movements, traversability, graspability and at least one physical property of the object.

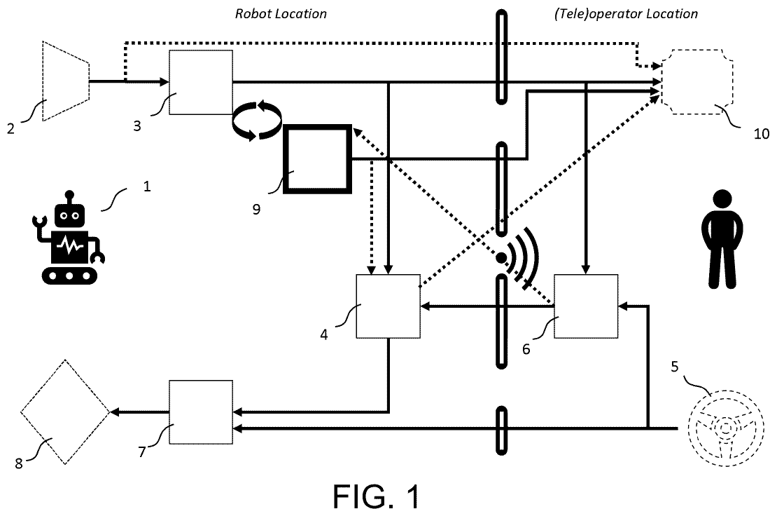

FIG. 1 provides an overview over the entire teleoperated robot system. The system comprises a robot 1 equipped with one or a plurality of sensors 2 physically sensing the environment of the robot 1. The environment of the robot 1 is the work area of the robot 1. The output from the sensor is 2 is provided to a scene understanding module 3 that analyses the sensor information in order to provide an understanding of the scene including for example detection of objects from the sensor information and estimation of the object pose.

The scene understanding module is a software module executed by a processor of the robot 1. The scene understanding module 3 analyses the perception data for at least one of the following aspects: detection/existence of objects and/or obstacles, classification of objects, analysis of relation of objects, prediction of dynamical object movements, orientation and/or pose of objects, traversability, grasp ability, state of objects and physical properties. Traversability of an object means that the respective object can be passed by the robot or a person, for example in case of a door. The object state in this context defines certain inherent states an object can have, for example scissors in an open state, or an appliance switched on. Dynamical object movements define for example speed and direction of the entire object including rotational movements with respect to symmetry of the object like rolling. Physical properties can comprise weight, relatedness, centre of mass, friction coefficient or the like.

Information on the scene understanding of the robot 1 is forwarded by the scene understanding module 3 to a planning module 4. The planning module 4 is also a softer module executed on a processor of the robot 1. It is to be noted, that processors used for executing the respecting software modules include a single processor or a plurality of processors which are communicatively coupled to each other in order to exchange information, intermediate results. All processors are connected to a memory on which the software to be executed on the processor is stored.

Planning module 4 plans one or multiple motion trajectories for the robot 1 required for task achievement. A task may be a single goal or a series of subgoals (subtasks). The description of the present invention always refers to the “robot” 1 in general. However, all explanations provided may also to only a part of the robot like for example a robotic arm or similar embodiment capable of performing object manipulation.

The planning module 4 may generate a representation to evaluate the quality of human operator motion signals with respect to those (sub-)goals, but also with respect to the robot's capabilities and limitations, and possible interactions with the environment (e.g. collisions).

The planning module 4 may compute meaningful robot poses/positions based on interaction opportunities with the environment. e.g., where/how to grasp a cup. These robot poses/positions can be shown to the operator to provide suggestions/guidance in future motion control, or could be used as sub-goals for future motion plans. For example, a target grasp pose can be suggested concretization of a human intention to pick up a specific object.

Alternatively or in addition, the planning module 4 plans or predicts an extension of the current human motion trajectory and evaluates possible additional signals that can be added to improve the quality of the motion. This improvement may improve efficiency, collision prevention, risk, or the like.

The result of the planning module 4 is then used to create a motion control signal for the Robot 1. The motion control signal results from an evaluation how to combine the planning result with the given human operator control input. This evaluation can consider additional goals and is performed in a cooperative control module 7. The cooperative control module receives the results from the planning module 4 and also the input made by the operator of the robot system input via a teleoperation interface 5.

The motion control signal is then provided to actuators 8 of the robot 1, finally controlling motions of robot 1.

In addition to information provided by the scene understanding module 3, the planning module 4 may also receive information on an intended goal that shall be achieved and which is input by the operator. Such goal(s) might be explicitly set by the operator or inferred by an operator goal estimation module 8 which is connected to the teleoperation interface 5 to acquire information input by the operator. The intended goal can be inferred from any combination of prior control inputs, current perception of the situation by the robot 1 and additional sensing of the human operator (not shown in the drawing and including for example eye tracking, operator arm motions, . . . ). In order to consider the perception of the situation made by the robot 1, the scene estimating unit is also connected to the operator goal estimation module 6.

The motion control signal enabling assistive motion control is generated by merging a control signal generated by the robot 1 itself based on the output of the planning module 4 with the human operators control signals input via the teleoperation interface 5, overwriting human control signals or interleaving with the human control signal.

Preferably, the software does not perform fully automated behaviours, i.e., those which are not influenced by the human operator. This might be e.g. due to humans having superior understanding capabilities and flexibility to adapt to unknown environment conditions, due to legal implications that a human has to be in control, or due to desired effects for the human that are improved through agency (e.g. social/entertainment experiences).

Generating a motion control signal in a cooperative control module 7 based on perception of the environment performed by the sensors 2, analysing the perception data in a scene estimation module 3, planning robot motion and a planning model 4 preferably considering the results of the operator goal estimation module 6 and controlling actuators 8 based on the motion control signal is known in the art. In addition to these known components, the robotic system according to the present invention further provides an uncertainty prediction module 9.

The above provided explanations of the process of generating control signals for controlling the robot's movements are all based on environment perception performed by the sensors 2 which is then analyzed by the scene estimation module 3. Necessarily, the quality of the assistance functionality of the entire robot system depends on the quality of the planning output, which directly depends on the quality of the scene understanding made by the scene estimation module 3. The higher the uncertainty of the input information, the lower the quality of the Asst system will be in the end.

As is true for any computer module, the scene understanding will not be perfect, as it might suffer from sensor noise and sensor limitations such as field of view and resolution. Further, the processing of the information derived by the sensors 2 leads to uncertainty in perception even in case of accurate sensor data. For example, the quality of object classification using machine learning depends on similarity between training and application data. The uncertainty in perception may also be increased due to specific aspects of the scene itself, which are independent from sensor noise and sensor limitations. Examples for such aspects are a distance of the sensor 2 to an object, occlusions due to other objects or parts of the robot 1, motion of the sensor 2 with the robot 1, presence of reflective surfaces, and many more. At least some of the aspects of the scene can be modified to create a modified scene that results in an improvement of the respective uncertainty.

The scene understanding module 3 in the proposed robotic system is able to measure or evaluate the uncertainty in the estimation of different aspects of the scene. This can be represented e.g. as (parametric) probability distribution over possible states (e.g. position of an object), as epsilon-confidence bounds (true value is within bounds with >epsilon probability), as the probability of an estimate of being correct.

The scene understanding module 3 might additionally receive information from the planning module 4 and/or information on the inferred operator goals from the operator goal estimation module 4 and uses this to determine the relevance for different types and/or dimensions of uncertainty in the current situation.

Using this feature of providing information on uncertainty by the scene understanding module 3, a predicted change in uncertainty assuming certain changes of the environment can be determined. These assumed changes of the environment can generate a modified scene and a change in the resulting uncertainty can thus be calculated based on the modified scene. The calculation of the one or more uncertainties for the modified scene is performed in an uncertainty prediction module 9 reusing the capabilities of the scene understanding module 3 to estimate uncertainties as indicated by the circular arrows in the illustration in FIG. 1.

First, the information on the actual scene is derived from the scene understanding module 3 and is provided to the uncertainty prediction module 9. The information on the scene is then modified based on for example an assumed manipulation of an object (removal of an object occluding another object). The scene estimation is then repeated for the modified scene resulting in a modified scene uncertainty with respect to the previously occluded object. Comparing the modified scene uncertainty with the actual scene uncertainty provided by the scene understanding module 3, it can be predicted how the uncertainty would change, or how a new uncertainty estimate would look if, e.g., one object would be removed from the situation. This process is referred to as “uncertainty prediction”.

The system may determine a plurality of possible modifications of the actual scene. However, not all of these modifications result in an improvement of uncertainty are only improve uncertainty of aspects of the scene which are not relevant for achieving the desired goal. Which modifications in the environment will be considered and communicated to an operator of the robot system, could be determined based on one of the following aspects (or combinations thereof): the distance of the object to which the respective uncertainties related to the robot 1 (including considering reachability), estimated weight of objects, distance to the target object according to the operator's goal, a predetermined or learned list of ‘high influence’ objects i.e. changes of which will likely/often impact uncertainty measures. The latter could also contain individual lists for different types/dimensions of uncertainty and selection is done based on the relevance of those, or changes are selected relative to aspects that have a high uncertainty (above some threshold), e.g., changes with small distance.

In case that a possible improvement can be determined for a plurality of uncertainties, the order in which modifications in the environment will be considered could be determined based on (combinations of) e.g.: any of the above mentioned aspects (distance, weight, . . . ), operator input after communicating possible modifications to the operator, estimated interaction complexity (e.g. learned from past planning cost with objects of similar class, size, . . . ).

The number of modifications that can be applied to the environment that will be considered is determined based on, e.g.: a fixed maximum number (of modifications for necessary manipulations for all intended modifications), a fixed computational budget used for uncertainty prediction, or a user input.

The type of determined modifications of the environment can be, e.g.: removing an object, moving an object to a different position, changing the pose of an object, opening/closing a hatch-like thing.

It is to be noted that the listings above concerning the aspects and types of modifications only present some examples and is not limiting for the present invention. However, these aspects and types proved to be the most valuable.

It is specifically preferred that the planning module 4 computes a plan for the assumed modification of environment including determination if the modification is feasible at all. The result of such an additional planning step could even be used in order to avoid that are determined potential modification is communicated to the operator in case that it is considered not to be feasible. Further, the result of such plan based on the assumed modification of the environment can be used in order to calculate cost of achieving the modification, for example, with respect to additional time needed for performing the manipulations necessary in order to achieve the modified scene.

In one possible implementation, uncertainty prediction for a modified scene is performed by the uncertainty prediction module 9 reusing the capabilities of estimating uncertainties in the scene estimation module 3, based on a simulation of the environment generated by the uncertainty prediction module 9. For example, the simulation removes the points belonging to one object from a point cloud representation of a situation perceived by the robot sensors 2 and models the changes to the point cloud of another object behind it using ray tracing and a stored model of the most likely type of the object as represented by the scene understanding module 3. This new point cloud representing the modified scene is provided to the scene understanding module 3, which computes new uncertainties for this modified scene.

In another possible implementation, uncertainty prediction uses a machine learning model (e.g. a deep neural network) trained to output a change of uncertainty, potentially for different objects in a scene at the same time. This model is trained prior to deployment (but might continue learning during deployment), e.g. using a simulator and/or real-world data which create input of a (randomly generated) situations with multiple objects and infrastructure items and as training signal uses the difference between the uncertainty estimates provided by the scene understanding model 3 before and after a given object is removed from the scene (virtually/physically). This version of the uncertainty prediction module 9 has learned what changes could improve the uncertainty and by how much. Therefore, no simulations need to be performed. The results from previous simulations can be used for generating training data and train the model.

In order to communicate the improvements that may be achieved by modifying the scene, it is determined whether the scene modification results in an improvement of an uncertainty. If so, the modification that needs to be applied to the work area of the robot 1 is communicated to the operator of the system using an operator interface 10. During an interaction with the operator, the system's operator interface 10 can, in addition to the determined modifications of the environment, convey information about the possible improvement in. This allows the operator to decide, if it wants to first perform an action to change the environment before continuing with the originally planned actions towards its goal.

Optionally, the system will select one or more scene modification/uncertainty change pairs for display from all possible pairs of scene modifications/uncertainty changes. Criteria for the selection of such pairs are at least one of the following (and also combinations thereof): the predicted change of uncertainty is a reduction in uncertainty and the reduction (improvement) is calculated based on a comparison of the actual scene uncertainty and the modified scene uncertainty; the improvement of uncertainty is in a relevant dimension/type for the current plan/user goal; the predicted improvement of uncertainty is the maximum reduction among all computed predictions; the plan for the change of the environment is feasible or of certain maximum cost.

Optionally, the system will also render a representation of the required action to change the environment in a desired way, as computed by the planning module 4.

The operator interface 10 may use a plurality of different ways to communicate with the operator. Preferred examples are:

Displaying a scene representation in which the colors and/or transparency of objects indicate the uncertainty of the respective pose. For example, a color scheme can be used ranging from green (low uncertainty) to red (high uncertainty).

Alternatively or in addition, an overlay of multiple possible interpretations can be used. For example, multiple object poses estimates can be displayed at the same time in case that the respective uncertainty exceeds a predefined threshold.

Alternatively, in addition to displaying the objects in the representation of the environment, an uncertainty distribution related to the object can be displayed together with the object, for example, by projection onto rotation axes.

In addition to rendering uncertainties in the operator interface, it is also possible to render changes in uncertainty in the user interface. This can be done by oscillating colours between the actual scene uncertainty and the corresponding modified scene uncertainty, a marker, blinking, changing colour or displaying a numerical value on an object or occluding another object. Thus, the occluding object is indicated as being responsible for the resulting uncertainty change and displaying a numerical value can directly inform the operator on the achieved improvement. The same is valid for a respective colour change which also directly informs the operator on the achievable improvement. Further, simulated shadow cones behind occluding objects can be used for intuitive understanding which objects badly affect the certainty of, for example, pose estimation.

Generally, any kind of operator interface may be used that is able to provide information to an operator of the robot system. However, it is preferred to use a visualisation. Preferred interfaces therefore are: a virtual reality headset, a display screen (fixed or handheld), a 3D prediction area (“Cave”), a projection onto a screen and augmented reality glasses. However, other communication channels may be used, for example Bible tactile actuators integrated in wearable devices, such as the tactile glove.

Receiving inputs from the operator of the system, the operator interacts with the teleoperation interface 5. Preferred teleoperation interfaces are: a joystick, a virtual reality controller, a bearable tracking its position (“data glove”), the treadmill, an external motion capturing setup (for example a plurality of distributed cameras), the touchscreen (which then can also be used in order to communicate information to the operator as the operator interface 10), a computer keyboard/mouse, a steering wheel, case tracking, a natural language interface, compliant robotic actuators.

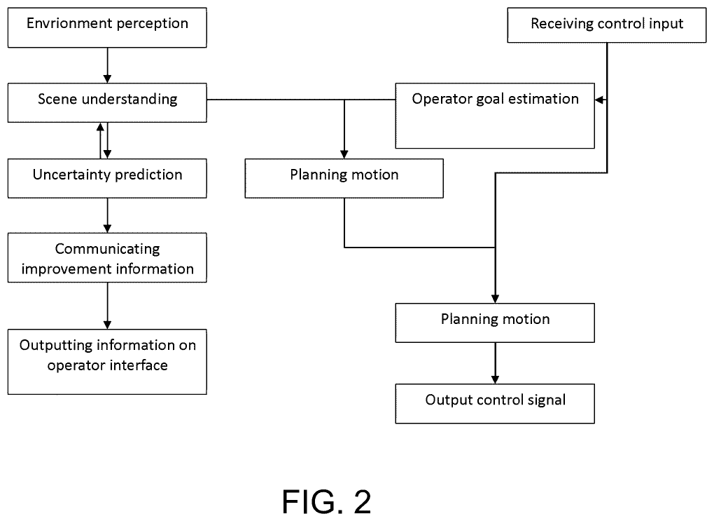

FIG. 2 shows a simplified flowchart summarizing the different steps of the procedure explained above in greater detail.

First, the environment of the robot 1 is received in the environment perception step, and the sensor output is provided to the scene estimation module 3. The scene understanding module 3 receives information from the robot sensors 2 and performs scene understanding and extracts a representation of the local environment, including position, pose, class, etc. of available objects and infrastructure elements with the respective uncertainties.

Uncertainty prediction then estimates how uncertainties of one or more aspects will change for selected possible changes of the environment. This could be implemented in a self-contained manner or as an interaction between the scene understanding module 3 and the uncertainty prediction module 9.

After information on the uncertainty improvement and/or the necessary modifications of the environment causing such improvement is sent through some communication infrastructure including an operator interface 10 to the location of the operator, it is communicated to the operator through the operator interface 10. Based on this, the operator can understand the situation at the location of the robot 1 and how scene modification can improve the situation to enable better assistance through changing the environment to reduce uncertainty.

In response to the information communicated to the operator, the operator may decide to perform the suggested scene modification and use the teleoperation interface 5 to provide desired control input for the next motions of the robot 1. The control input is received by the teleoperation interface 5 and is sent through the communication infrastructure to the robot 1 and to the operator goal estimation module 6.

The operator goal estimation module 6 uses information about the situation provided by the scene understanding module 3 and received control input by the operator to infer the most likely goals of the operator in the remote environment.

The planning module 4 uses information from scene understanding module 3 together with the results from operator goal estimation module 6 to compute feasible motion trajectories for the robot 1 to reach the operator goal.

The cooperative control module 7 receives the planned trajectories from the planning module 4 and the desired operator control input from the teleoperation interface 5 and combines them into a sequence of commands to the different robot actuators 8, which make it perform a desired motion.

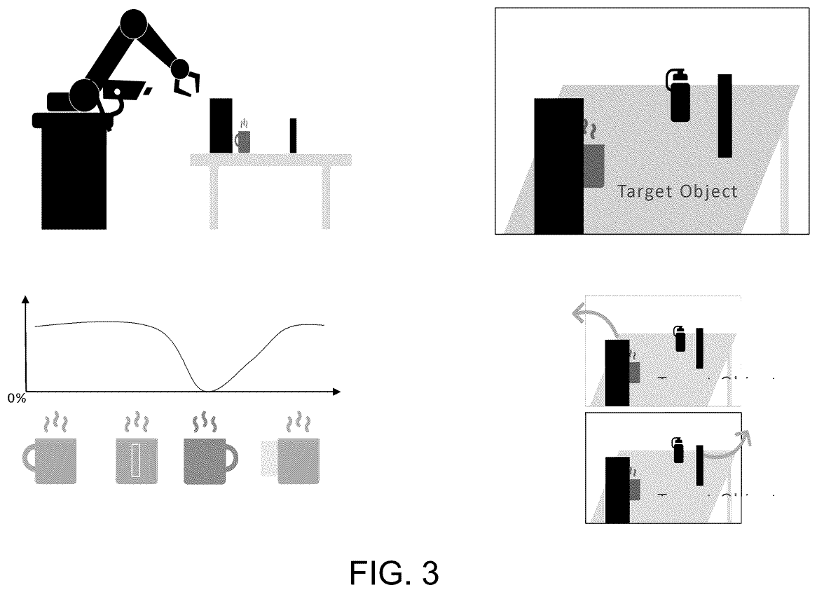

FIG. 3 illustrates an exemplary situation in a work area of the robot 1 and how it is treated according to the present invention. The upper left part of FIG. 3 shows a situation in which a robot 1 equipped with a camera as sensor 2 receives the task or goal that requires manipulation of the mug standing on the table, for example filling it a passing it to a person. The black blocks that are placed on the table as well are other objects which are not necessary or beneficial for achieving the dedicated goal. Rather, these objects do not need to be identified or classified and their pose is irrelevant for planning a certain assistance. Presence of these objects may even be negative with respect to scene estimation.

Turning to the upper right part of the FIG. 3, showing a scene representation based on in image captured by the camera of the robot 1, it can be recognised that the large black block is an occluder partially occluding the mug. The second occluder (smaller black block) may also be a not identified object, but its position in the perspective of the camera of the robot 1 is such that it does not seem to occlude any object relevant for scene estimation.

While the portion of the mug that is not occluded by the big occluder possibly allows to identify the determined object as a mug, it is not possible to determine the pose of the mug with confidence. The left lower part of FIG. 3 shows four distinct poses of the mug. From an image captured by the camera of the robot 1, only the third pose of the mug can be excluded. Accordingly, the curve showing the uncertainty of identifying certain poses shown below the curve shows a significant drop of the uncertainty for this third pose. However, due to the big occluder occluding a relevant part of the mug in the image captured by the camera of the robot 1, the pose of the mug can only be determined with high uncertainty.

It is to be noted that the example refers to the pose estimation only. However, similar considerations would apply if, for example, the identification of the mug is only possible with high uncertainty. This could be the case when the portion of the mug which is occluded is larger and/or even include its opening.

The lower right part of the figure shows two potential scene modifications: the upper scene modification suggests to remove the big occluder. This would result in the entire mug to be visible in the image captured by the camera. Turning back to the lower left part of FIG. 3 it is obvious that in such a case the four poses could well be discriminated from each other based on the captured image. For such a modified scene the uncertainty for the pose estimation would therefore be significantly be improved. According to the invention, based on the assumption that the big occluder is removed, the corresponding modified scene uncertainty relative to the mug (in the example the pose of the mug) is calculated and compared to the actual scene uncertainty for the pose of the mug which is derived from a partial occlusion of the mug. The system will identify that removal of the big occluder results in an improvement of the uncertainty impose estimation of the mug and will output respective information to the operator. The improvement is the result of a comparison between the actual scene uncertainty provided by the scene understanding module 3 and the modified scene uncertainty. The modified scene uncertainty is predicted based on an assumed scene which deviates from the actual scene by applying a virtual manipulation. Virtual manipulation means that the objects identified in the actual scene are not manipulated (moved), but only an internal representation of the perceived scene is adapted according to the virtual manipulation. Such an adapted scene representation is then used an anew input for object identification (including their poses). This new object and pose estimation are the basis for the modified scene uncertainty calculation. This communication may indicate the potential scene modification (big occluder repositioning or removal) to the operator then may decide on controlling the robot 1 in order to reposition or remove the big occluder.

On the other hand, the lower part illustrates a potential removal of the small occluder. It can be seen in the drawing, that such removal does not have any effect with respect to perception of the bottle positioned at the back end of the table. Thus, regarding, for example, pose estimation or classification of the bottle, no change in the corresponding uncertainty would result from the modification of the scene by removing the small occluder. In such a case, the system would not communicate the potential scene modification to the operator in order to avoid unnecessary communication be performed with the operator but only in case that the communicated information would help the operator controlling the robot 1.

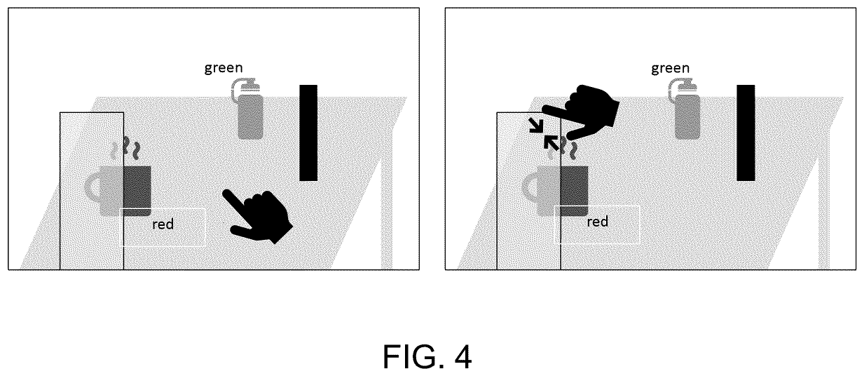

FIG. 4 illustrates one possible display for informing the operator about the advantageous potential scene modification by removing the big occluder. The left part of FIG. 4 shows two identified objects, namely the mug and the bottle. However, the poses of the two identified objects may not be estimated or identified with the same certainty. In the present case, the mug's pose is only guessed and therefore shown to have high uncertainty. In the displayed representation of the scene as captured by the camera of the robot 1, the mug is therefore displayed in red colour. Contrary, the bottle, which is fully visible in the camera image and therefore allows a precise estimation of the bottle's pose, is shown in green colour.

The small occluder shown on the right side of the table does not make any change to the estimated uncertainties if the small occluder is repositioned or removed. Thus, this small occluder is shown as a black rectangle indicating its lack of influence on the scene.

On the other hand, the big occluder occluding parts of the mug is shown in green colour with transparency. The transparency allows to show the mug's pose that is currently assumed to be most likely. The green colour indicates that an improvement of uncertainty estimation is possible in case that the position of the big occluder shown in green is modified.

The right side of FIG. 4 corresponds to the situation presented already in the left part of FIG. 4 but with the human controller representation (Black hand) being moved to the big occluder indicating repositioning or removal of the big occluder.

The invention particularly regards the estimation and improvement of uncertainty of 6D object pose distributions as a tool for supported teleoperation for improving teleoperation performance. Some considerations related to the above described invention help to understand the invention and its motivation better and will be described hereinafter.

Support functions in teleoperation in a noisy environment require knowledge about object poses and their uncertainties (probabilities) for deciding whether and how to offer support, and a human operator can make informed decisions on accepting AI support based on a transparent state of AI scene understanding. Further, the invention regards active perception for minimizing task-relevant pose uncertainties.

The proposed system and method solve the problem of, for example, limited sensor coverage of occluded objects reducing availability and quality of AI support in assisted teleoperation and cooperative robots. It is not trivial for the operator to understand which objects are occluded for which camera and how AI support could improve optimally by moving objects if multiple sensors are involved.

The study of object pose distributions deserves more contributions for the field of (tele-) robotics. A task-oriented, robust assisted telerobotics system is desired. The estimation of full 6D pose distributions will provide more value than a simple maximum-likelihood point estimate of object poses, because even with a large variance in multiple dimension estimation, the operator may still be able to execute grasping, e.g., the uncertainty of rotation around z-axis does not contribute to the grasping an upright cylindrical can.

Many factors of uncertainty have impacts on pose estimation, which are not addressed by a point estimate. For instance, some objects have completely symmetrical structures, such as cubic objects or cylindrical objects (e.g., a bowl or soup can). In such cases, there is no single correct pose, but rather multiple correct poses, because each rotation around the symmetry axis gives a different and equally correct pose. It can usually be assumed that object geometry is known before pose estimation, allowing offline analysis of object symmetries. However, occlusion (self-occlusion or occlusion by other objects) can effectively make views of an asymmetric object ambiguous, e.g., when viewing a mug when its handle is invisible. Furthermore, sensor noise naturally affects the accuracy of pose estimation. Thus, the pose of objects is expressed in terms of a distribution, rather than a single 6D pose, because sometimes valuable information is extracted from a distribution with a large variance. The distribution may be used to evaluate effects of certain changes of the environment (change of camera angle, removal of occluder) to pose uncertainty.

The representation of 6D pose distributions can be generally divided into parametric models and non-parametric models, e.g., expressing the translational uncertainty with Gaussian mixture models is parametric, whereas outputting hundreds or thousands of poses simultaneously and generating a probability density function is non-parametric.

In a known non-parametric method, each grid point or particle represents a potential pose hypothesis, and the likelihood of each hypothesis is estimated. To improve the accuracy of the uncertainty estimation, a dense grid with thousands of particles is tested. While the dense grid representation provides a better knowledge of the scene, it is computationally expensive. Thus, two further implementations of non-parametric methods were evaluated: a grid-based and a data-driven implementation. With a grid-based approach, the space is discretised, and the size of grid can be adjusted to analyse the impact on the pose uncertainty. In the data-driven approach, a neural network model learns to estimate the probability of different poses given a scene point cloud. However, the data-driven approach requires a trained deep network for each individual known object, and the training requires high computing resources.

These results can be adapted into the existing assisted tele-robotics setup. An efficient and sufficiently rich representation for pose distributions is developed. To address periodicity of orientation, Fisher distribution and Bingham distribution have been proposed as improvements over Gaussians. Moreover, unimodal distributions are typically not suitable for cases with object symmetries, e.g., rotational and up-down symmetry in a cylindrical object. Parametric representations are typically more compact and computationally cheaper than non-parametric ones, which makes them more suitable for online use. A hypothesis is to develop a hybrid approach that uses a mixture of Gaussians for position and a mixture of Binghams for orientation. Different representations of pose distributions are estimated and compared to the proposed approach to understand the capabilities and limitations, and then aim for a suitable solution that can be published and applied to teleoperation robots.

The modelled pose uncertainties may be used with simplified models within this project for object grasping:
Voxelization Approach: build voxelized probability density estimates of a volume around the object of interest that can be used for estimating a collision probability; and
Sampling Approach: sample poses from pose distribution, simulate planned grasp, quantify risk of collision for different grasps.

In a scene with multiple objects and mutual occlusions, pose uncertainty distributions can also be used to predict the impact of operator actions on the pose uncertainties. This consideration for pose estimation is a core aspect for the invention as explained above in detail. For example, first removing object A that largely occludes object B will reduce pose uncertainty of B. Such a prediction can be communicated to the operator resulting in a closed loop scenario, where the support system tells the operator how support quality could be improved, and the operator may decide to improve AI support by reordering the task sequence, or by removing occluders first, or delaying an operation until pose uncertainty has settled to an acceptable level.

In a more general sense, explicit representation of object pose uncertainties provides the opportunity to perform Active Perception (AP) for actively minimizing pose uncertainty. AP can be an optional block. AP was first introduced two decades ago and is a key concept for intelligent robots. However, it has rarely been applied to teleoperation because actuators and resources of robots cannot usually be exclusively used for active perception. An approach for active perception in teleoperation with minimal operator disturbance is preferred, e.g., by biasing the actuator trajectories and adapting the null space, e.g., modification of the middle joints for improved perception with an attached sensor without changing the position of the end-effector. The teleoperation system may simply ask the operator to position sensors manually for improved perception. Advantageously, the system could use a second, currently unused arm, for active perception, or take over control of the whole robot in the absence of the operator, e.g., during time-sharing of one operator on multiple robots. Active perception for minimizing the task-relevant uncertainties may be used, based on previously developed pose distributions. Example: where to position the wrist-mounted camera next to minimize the risk of hand-to-object collision during grasping. Active Perception could be extended in the context of robotics by pushing objects with an actuator such that the position uncertainty of the volume where the pushing occurred is reduced to zero (i.e., actively aligning the object in some axes).

### Assumptions and Limitations:

Object geometry is learned/known in advance;
Grasp planning based on pose distributions is not part of this project, but already planned as a future task within known tele-operation projects;
Visualization of pose/pose uncertainty to the operator will be done using an existing or simplified interface, but specific design of the HMI is not crucial.

Finally, a system for the estimation of object pose distributions for telerobotics as well as a cooperative decision mechanism for minimizing uncertainty is achieved.

This approach is applicable for robotics in general and specifically for assisted telerobotics. For example, assisted telerobotics may offer improved object pose estimation as well as offering assistance only when the probability of successful assistance is high, minimizing object collisions, toppling of objects and thus maximizing operator satisfaction and speed. Furthermore, the proposal improves the perception for more complex object manipulations than pick-and-place.

One aspect related to the present invention is to model and quantify knowledge about object poses through 6D pose distributions tailored for use in robotics and teleoperation. State-of-the-art systems focus on point estimates of poses or on independent representations of 3D position and 3D orientation as disclosed in Deng, Haowen, et al. “Deep Bingham networks: Dealing with uncertainty and ambiguity in pose estimation.” International Journal of Computer Vision 130.7 (2022): 1627-1654 or Bui, Mai, et al. “6D Camera Relocalization in Ambiguous Scenes via Continuous Multimodal Inference.” Computer Vision-ECCV 2020: 16th European Conference, Glasgow, UK, Aug. 23-28, 2020, Proceedings, Part XVIII 16. Springer International Publishing, 2020. No other method seems to consider optimizing the task-relevant aspects of a pose.

Assisted tele-robotics for robust manipulation requires accurate pose estimations to offer operator support in the most difficult control tasks of grasping and navigating crowded areas. As a perfect real-time object pose estimation is practically impossible, our research will contribute to successful assistance by providing pose uncertainty transparency which helps an operator to adjust its actions for better cooperation with the system, either by selecting target grasps that are more robust to inaccurate poses or by providing active perception support in changing the scene to reduce uncertainties specifically for task-relevant pose dimensions.

It may use several RGB-D cameras and a robotic platform with movable cameras that can be teleoperated. Such a setup is available within other projects with several static and wrist-mounted RGB-D cameras.

The proposed system and method solve the problem of limited sensor coverage of occluded objects reducing availability and quality of AI support in assisted teleoperation and cooperative robots. It is not trivial for the operator to understand which objects are occluded for which camera and how AI support could improve optimally by moving objects if multiple sensors are involved.

In robotics manipulation scenarios, objects often occlude each other and thus reduce available sensory information about their identity, pose, or configuration.

For support of a human, the AI system needs sufficiently reliable pose information to offer assistance to the operator, e.g., for grasping.

It is known to estimate and visualize the AI's confidence of object poses but not communicate how to improve them.

The system according to the invention predicts improvement in object pose uncertainty (confidence) for certain user actions, e.g., moving or removing occluding objects and visualize these actions to the human.

This enables operators to decide to reorder their task and first move occluding objects to get better support for other parts of the scene.

A robotic system according to the invention may support a human operator in its task by taking over certain actions, while the operator should always be in control about all behaviors (example: assisted teleoperation).

The proposed method gives the operator an intuitive understanding how AI support for specific objects could improve when he or she takes certain actions (e.g. move an object to the side).

The robot/AI infers the desired actions of a human and computes how to best support her/him, for example by performing final detailed grasping control automatically in a teleoperation setup.

To perform this support, the robot requires to know certain attributes of the target object (e.g. pose) with a certain accuracy.

These attributes can be estimated based on the available sensor data, for example from a camera mounted on the robot. However, the environment setup will influence the uncertainty of this estimation, for example through other objects occluding parts of the target object.

The human could perform actions to improve the robot's estimation (e.g. move an object out of the way, change the order of selecting target objects, . . . ), but does not know how. Instead, the robot analyzes the scene for influencing objects and simulates how attribute estimation would change if these objects would be moved or removed.

It then visualizes the impact of selected best actions on estimation uncertainty and expected support quality to the human user, e.g. rendering predicted object pose uncertainty in augmented reality.

What is claimed is:

1. A method for assisting an operator in operating a telerobot system, the telerobot system comprising a robot, at least one sensor, a processing unit and an operator interface, the method comprising the steps of
physically sensing a working area of the robot by the at least one sensor;
detecting objects and estimating at least one of an object property, object state and object relation to another object;
estimating, for at least one object, an actual scene uncertainty related to the object;
predicting a modified scene uncertainty related to the object assuming a scene modification; and
determining whether the modified scene uncertainty has improved compared to the actual scene uncertainty and, if an improvement is determined, communicating the corresponding scene modification using the operator interface.

2. The method according to claim 1, wherein the method further comprises a step of selecting one or more scene modifications based on a predicted future operation of the operator.

3. The method according to claim 1, wherein a task is divided into subtasks and a sequence of the subtasks resulting in an improved uncertainty is communicated to the operator.

4. The method according to claim 1, wherein communicating scene modification includes outputting information on the determined uncertainty improvement.

5. The method according to claim 1, wherein a cost for executing the scene modification is estimated and communicated to the operator.

6. The method according to claim 1, wherein an operator request is received specifying an actual scene uncertainty for which a modified scene uncertainty which is improved compared to the actual scene uncertainty shall be determined.

7. The method according to claim 1, wherein the robot autonomously executes the scene modification corresponding to a determined improvement of the modified scene uncertainty.

8. The method according to claim 1, wherein the operator interface outputs a scene representation an visualizes the actual scene uncertainty or the modified scene uncertainty.

9. The method according to claim 1, wherein the scene uncertainty is an uncertainty of one of: pose of an object, object existence, object detection, object classification, classification of object instance, object state, relation between the object and at least one other object, prediction of dynamical object movements, traversability, graspability and at least one physical property of the object.

10. Telerobot system comprising a robot, at least one sensor, a processing unit and an operator interface, the telerobot system being configured to execute the method according to claim 1.
